(19) United States
(12) Patent Application Publication
(10) Pub. No.: US 2009/0086089 A1
(43) Pub. Date: Apr. 2, 2009

(54) VIDEO/AUDIO OUTPUT APPARATUS

(76) Inventors: Takayuki MATSUI, Osaka (JP); Kohei Hashiguchi, Kyoto (JP)

Correspondence Address: MCDERMOTT WILL & EMERY LLP, 600 13TH STREET, NW, WASHINGTON, DC, 20005-3096, US

(21) Appl. No.: 12/239,017

(22) Filed: Sep. 26, 2008

(30) Foreign Application Priority Data
Sep. 27, 2007 (JP) 2007-251409
Sep. 5, 2008 (JP) 2008-227783

(51) Int. Cl. H04N 7/01

(52) U.S. Cl. 348/441; 348/E07.003

(57) ABSTRACT

A format converter resolution converts first video data input to a video input device, thereby generating second video data. An HDMI converter converts the second video data into an HDMI signal. A first clock generator generates a second clock signal having a frequency corresponding to a resolution of the second video data based on a first clock signal input to the video input device and supplies the second clock signal to the format converter and the HDMI converter. A second clock generator generates a third clock signal having a frequency corresponding to a resolution of the HDMI signal and supplies the third clock signal to the HDMI converter. The format converter converts the first video data into the second video data based on the first clock signal and the second clock signal. The HDMI converter converts the second video data into the HDMI signal based on the second clock signal and the third clock signal.

### BACKGROUND OF THE INVENTION

1. Field of the Invention

The present invention relates to a video/audio output apparatus capable of outputting a digital signal when a DVD player, a DVD recorder, a BD (Blu-ray Disc) recorder or the like is connected to a receiver such as a digital TV, a video/audio output apparatus controlling program and a resolution converting method.

2. Description of the Related Art

FIG. 6 shows a schematic structure of a system of a receiving apparatus 30 which is HDMI (High Definition Multimedia Interface) connected to a video/audio output apparatus B according to the prior art. The video/audio output apparatus B and the receiving apparatus 30 are connected to each other through an HDMI cable 40. An HDMI transmitting apparatus 10 in the video/audio output apparatus B transmits input video data and audio data to the receiving apparatus 30 through the HDMI cable 40.

The video/audio output apparatus B includes a tuner 1, a DVD drive 2, a CPU 3 having a built-in B/E LSI, and the HDMI transmitting apparatus 10. The HDMI transmitting apparatus 10 includes a video input device 11 for inputting video data from the tuner 1 or the DVD drive 2 through the CPU 3, a CS converter 22 for carrying out a color space (CS) conversion of the video data, an audio input device 12 for inputting audio data supplied from the tuner 1 or the DVD drive 2 through the CPU 3, a video/audio synthesizer 14 for synthesizing the video data input from the video input device 11 with the audio data input from the audio input device 12 synchronously, an encrypting device 15 for encrypting the video/audio synthesized data, an HDMI output device 16 for converting the video/audio synthesized data into an HDMI signal and outputting the HDMI signal to the outside, a clock generator 17 for generating an outputting clock signal CK1 from a clock signal CK0 input synchronously with the video data in the video input device 11, and a register 18 for switching an operation mode of each portion upon receipt of a set request given from the CPU 3.

In the HDMI transmitting apparatus 10, the outputting clock signal CK1 is generated based on the clock signal CK0 input to the video input device 11. When a resolution of the video data fluctuates, therefore, the outputting clock signal CK1 also fluctuates. In an HDMI transmitting apparatus for encrypting and outputting a digital signal such as an HDMI apparatus, particularly, when a clock of the output video data (HDMI signal) is disordered, an output image is disturbed remarkably. In order to avoid the disadvantage, in the conventional HDMI transmitting apparatus, an output of the HDMI signal is temporarily stopped and is started again, and a reauthentication with a connecting apparatus is then carried out.

With reference to FIG. 7, next, description will be given to a sequence operation in input switch processing such as switching between the DVD drive 2 and the tuner 1 or an exchange of a DVD of a different type in the conventional HDMI transmitting apparatus 10. In the following description, it is assumed that the video data output from the DVD drive 2 are input in a resolution of 1080P (148.352 MHz in a clock signal) to the video input device 11 and are then output from the HDMI output device 16 immediately before the input switch processing.

When processing of switching a source for supplying the video data from the DVD drive 2 to the tuner 1 occurs in this state, the CPU 3 gives a request for input switch processing to the register 18 in the HDMI transmitting apparatus 10. In response thereto, the register 18 gives a notice of an output stoppage to the HDMI output device 16 (N1). After the stoppage of the output, an encryption of an HDCP (High-bandwidth Digital Content Protection System) related to a copyright is turned OFF, and the encrypting device 15 is brought into an initial state (N2). Subsequently, the CPU 3 carries out the input switch processing (from a DVD drive to a tuner) (N3). Then, the CPU 3 sets, to the register 18, the resolution of the video data after the input switch processing (N4). Here, a resolution of 1080i (approximately 74.176 MHz in a clock signal) is set. Thereafter, a notice that the output of the video data is started is given to the HDMI output device 16 via the register 18 (N5). Subsequently, authentication processing is carried out between the receiving apparatus 30, which is a connecting device, and the video/audio output apparatus B, and furthermore, the encryption of the video/audio synthesized data is started through the encrypting device 15 (N6). Subsequently, a notice of an output mute cancellation of the HDMI signal is given to the HDMI output device 16 via the register 18 (N7). A time interval (Th+Tc) required for completing image switching at the receiving apparatus 30 side depends on a system and is usually several seconds.

Referring to the above described drawback (the fact that the disorder of the clock in the HDMI signal remarkably disturbs the output image), the summary of a method of fixing an output resolution into the highest resolution has been described in Japanese Laid-Open Patent Publication (No. 2007-89013). However, the document has not disclosed a specific example.

With reference to FIG. 9, next, description will be given to a sequence operation in input color space switching in the conventional HDMI transmitting apparatus. In the following description, it is assumed that the video data output from the DVD drive 2 are input as an RGB signal to the video input device 11 and is color space converted (RGB→YCbCr) through the CS converter 22, and a signal thus obtained is output from the HDMI output device 16 immediately before the input color space switch processing.

When the color space switching occurs in the video data with a change in a reproducing media replacement in the DVD drive 2 in this state, the CPU 3 gives a request for the input switch processing to the register 18 in the HDMI transmitting apparatus 10. In response thereto, the register 18 gives a notice of an output stoppage to the HDMI output device 16 (Q1). After the stoppage of the output, an encryption of HDCP is turned OFF so that the encrypting device 15 is brought into an initial state (Q2). Then, the input switch processing (RGB→YCbCr) is carried out at the CPU 3 side (Q3). Thereafter, a color space (in this case, YCbCr) after the input switch processing is set to the register 18 (Q4). Subsequently, a notice for restarting an output of the HDMI signal is given to the HDMI output device 16 via the register 18 (Q5). Then, authentication processing is carried out together with the receiving apparatus 30, which is the connecting device, and furthermore, the encrypting device 15 starts the encryption of the video/audio synthesized data (Q6). Thereafter, a notice of the output mute cancellation of the HDMI signal is given to the HDMI output device 16 via the register 18 (Q7). A time interval (Tg+Th) required for completing image switching caused by the color space switching at the receiving apparatus 30 side depends on a system and is usually several seconds.

In the conventional HDMI transmitting apparatus 10, the video outputting clock signal CK1 is generated from the input clock signal CK0. When the resolution of the input video data fluctuates, therefore, the outputting clock signal CK1 correspondingly fluctuates. For this reason, a disturbance occurs on an image at the receiving apparatus 30 side connected to the HDMI transmitting apparatus 10. In order to avoid the drawback, conventionally, the output to the HDMI cable 40 is to be temporarily stopped. In the HDMI transmitting apparatus 10 for encrypting and outputting a digital signal such as an HDMI apparatus, particularly, when the outputting clock signal CK1 is disordered, an authentication to be executed for the encryption for every pixel clock is shifted so that a disturbance of an output image at the receiving apparatus 30 side becomes remarkable. Therefore, it is necessary to temporarily stop the output, and furthermore, to cause an input video resolution to fluctuate, and to then start the output again and to carry out a reauthentication together with a connecting apparatus. Thus, a time of several seconds is required before an image is output again.

### SUMMARY OF THE INVENTION

Accordingly, it is a main object of the present invention to rapidly implement input switch processing without a disturbance of an image in input switch processing such as switching between a media drive and a tuner or an exchange of media of a different type.

In order to achieve the object, the present invention has the following structure.

(1) The present invention provides a video/audio output apparatus including:

a video input device for inputting first video data and a first clock signal which is synchronous with the first video data;

a format converter for resolution converting the first video data input to the video input device, thereby generating second video data;

an HDMI converter for converting the second video data into an HDMI signal;

a first clock generator for generating a second clock signal having a frequency corresponding to a resolution of the second video data based on the first clock signal input to the video input device and supplying the second clock signal to the format converter and the HDMI converter; and

a second clock generator for generating a third clock signal having a frequency corresponding to a resolution of the HDMI signal and supplying the third clock signal to the HDMI converter,

wherein the format converter converts the first video data into the second video data based on the first clock signal and the second clock signal, and

the HDMI converter converts the second video data into the HDMI signal based on the second clock signal and the third clock signal.

The second clock signal generated by the first clock generator is generated from the first clock signal input to the video input device in a synchronous state with the first video data. When a resolution of the first video data fluctuates due to input switch processing such as switching between a media drive and a tuner or an exchange of media of different types, therefore, a frequency of the second clock signal also eventually fluctuates. When the HDMI converter outputs the second video data (HDMI signal) by using the second clock signal undergoing the frequency fluctuation, mismatching occurs between the resolution and an output resolution on a receiving apparatus side before the input switch processing so that an image is disordered.

On the other hand, in the present invention, two components are provided as a countermeasure to such a problem. One of them is a second clock generator and the other is a format converter. The second clock generator uniquely generates the second clock signal corresponding to the resolution of the HDMI signal and supplies the second clock signal to the HDMI output device separately from the first clock generator. Consequently, unlike the related art, the HDMI output device is disconnected from the clock signal which undergoes frequency fluctuations. The HDMI output device carries out an operation for outputting the HDMI signal in accordance with the third clock signal supplied from the second clock generator. The HDMI signal remains unchanged before and after the resolution conversion. In other words, the output resolution is fixed.

While the output resolution is fixed, the input resolution fluctuates. Therefore, it is necessary to convert the fluctuating input resolution into the fixed output resolution. For the conversion, the format converter is provided. The format converter resolution converts the fluctuating input resolution in accordance with the output resolution in the HDMI output device which is fixed.

As a result, in the input switch processing such as the switching between the media drive and the tuner or the exchange of the media of different types, the output resolution does not fluctuate even if the input resolution fluctuates due to the input switch processing. Accordingly, mismatching does not occur in a connecting relationship or an authenticating relationship between the HDMI transmitting apparatus and the receiving apparatus. Therefore, it is not necessary to stop the output of the HDMI signal from the HDMI transmitting apparatus to the receiving apparatus, eliminating the necessity of an output restart and a reauthentication. Accordingly, it is possible to rapidly implement the input switch processing without causing a disturbance of an image in the input switch processing.

(2) In a video/audio output apparatus according to the present invention, it is preferable that the HDMI converter should include:

a color space converter for converting a color space of the second video data into a desired color space; and

an HDMI output device for converting, into the HDMI signal, the second video data subjected to the color space conversion, wherein

the second clock signal is supplied to the format converter and the color space converter, and

the third clock signal is supplied to the HDMI output device.

(3) Moreover, an aspect of the present invention is directed to the video/audio output apparatus, further including:

a receiving capability information acquiring device for acquiring receiving capability information from a receiving apparatus which is a transmitting destination of the HDMI signal;

a receiving capability analyzer for analyzing the receiving capability information acquired by the receiving capability information acquiring device, thereby calculating a maximum resolution which can be received by the receiving apparatus; and

a resolution setting device for setting the maximum resolution calculated by the receiving capability analyzer to the format converter and the HDMI output device.

According to the aspect, the receiving capability information acquiring device acquires the receiving capability information from the receiving apparatus and the receiving capability analyzer analyzes the receiving capability information thus acquired, thereby calculating the maximum resolution which can be received. Furthermore, the resolution setting device sets, to the format converter and the HDMI output device, the maximum resolution which can be received. Consequently, it is possible to automatically set the maximum resolution to the format converter and the HDMI output device. Examples of the receiving capability information include an EDID (Extended Display Identification Data).

(4) In the video/audio output apparatus according to the present invention, the video/audio output apparatus may further include

an audio input device for inputting audio data,

the HDMI converter further includes a video/audio synthesizer for synthesizing the second video data and the audio data synchronously with the third clock signal, thereby generating video/audio synthesized data, and

the HDMI output device converts the video/audio synthesized data into the HDMI signal.

According to the aspect, it is possible to rapidly output the HDMI signal without a disturbance of an image and a voice in the receiving apparatus also in a specification for treating audio data in addition to video data.

(5) An aspect of the present invention is directed to the video/audio output apparatus, wherein the HDMI converter further includes an encrypting device for encrypting the second video data synchronously with the second clock signal, and

the HDMI output device converts the second video data thus encrypted into the HDMI signal.

According to the aspect, the second video data are encrypted by the encrypting device, the second video data thus encrypted are converted into the HDMI signal through the HDMI output device, and the HDMI signal generated by the conversion is output to the receiving apparatus. In the receiving apparatus, the HDMI signal (the second video data which are encrypted) are decoded and displayed. The encryption processing is synchronous with the second clock signal, and the output resolution is unchanged and the second clock signal is fixed. Although the second video data which are encrypted are treated, therefore, it is possible to rapidly output the HDMI signal without causing a disturbance on an output image in the input switch processing.

(6) An aspect of the present invention is directed to the video/audio output apparatus, wherein the HDMI converter further includes an encrypting device for encrypting the video/audio synthesized data synchronously with the third clock signal, and

the HDMI output device converts the encrypted video/audio synthesized data into the HDMI signal.

According to the aspect, the video/audio synthesized data are encrypted by the encrypting device and are output as the HDMI signal from the HDMI output device to the receiving apparatus. In the receiving apparatus, the HDMI signal constituted by the encrypted video/audio synthesized data is decoded and separated so that the video data and the audio data are generated. However, the processing of encrypting the video/audio synthesized data is synchronous with the third clock signal, and the output resolution is unchanged and the third clock signal is fixed. Although the encrypted video/audio synthesized data are treated, therefore, it is possible to rapidly output the HDMI signal without causing a disturbance on an output image in the input switch processing.

(7) A method of controlling a video/audio output apparatus according to the present invention includes the steps of:

giving an instruction for a mute of the HDMI output device in the input switch processing accompanied by a change in a resolution;

carrying out the input switch processing accompanied by the change in the resolution in the video input device:

executing a resolution conversion, with the output resolution maintained in an original condition, from a new input resolution subjected to the input switch processing to the same output resolution as the original output resolution through the format converter over video data transmitted from the video input device; and

cancelling the mute of the HDMI output device after completing the resolution conversion and restarting an output.

In this method of controlling a video/audio output apparatus, even if the resolution of the first video data fluctuates, the resolution of the second video data (the HDMI signal) is not changed. Accordingly, it is possible to carry out control capable of exhibiting the function and effect of the video/audio output apparatus according to the present invention.

(8) A method of controlling a video/audio output apparatus according to the present invention includes the steps of:

giving an instruction, when input switching accompanied by a resolution fluctuation of the first video data occurs in the video input device, for an output mute of the HDMI signal to the HDMI output device prior to an output of the first video data subjected to the input switching from the video input device;

outputting the first video data subjected to the switching from the video input device;

generating, through the format converter, the second video data subjected to the switching which have a resolution equal to a resolution of the second video data before the switching which are generated from the first video data before the switching, from the first video data subjected to the switching which are output from the video input device;

synthesizing the second video data subjected to the switching and the audio data synchronously with the third clock signal, thereby generating the video/audio synthesized data subjected to the switching through the video/audio synthesizer;

encrypting the video/audio synthesized data subjected to the switching through the encrypting device; and

cancelling the output mute of the HDMI output device and generating and outputting, through the HDMI output device, the HDMI signal subjected to the switching from the video/audio synthesized data subjected to the switching which are encrypted.

In this method of controlling a video/audio output apparatus, even if the resolution of the first video data which are input to the video input device fluctuates, the resolution of the second video data (the HDMI signal) is not changed. Furthermore, it is not necessary to execute a reauthentication with the receiving apparatus despite the transmission of the encrypted HDMI signal. Accordingly, it is possible to carry out control capable of exhibiting the function and effect of the video/audio output apparatus according to the present invention.

(9) A method of controlling a video/audio output apparatus according to the present invention includes the steps of:

giving an instruction, when input switching accompanied by a color-space fluctuation of the first video data occurs in the video input device, for an output mute of the HDMI signal to the HDMI output device prior to an output of the first video data subjected to the input switching from the video input device;

outputting the first video data subjected to the switching from the video input device;

generating, through the color space converter, the second video data subjected to the switching which have the same color space as a color space of the second video data before the switching which are generated from the first video data before the switching, from the first video data subjected to the switching which are output from the video input device; and

cancelling the output mute of the HDMI output device and generating and outputting, through the HDMI output device, the HDMI signal subjected to the switching from the second video data subjected to the switching.

In this method of controlling a video/audio output apparatus, even if the color space of the first video data fluctuates, the color space of the second video data (the HDMI signal) is not changed. Accordingly, it is possible to carry out a control capable of exhibiting the function and effect of the video/audio output apparatus according to the present invention.

(10) A method of controlling a video/audio output apparatus according to the present invention includes the steps of:

giving an instruction, when input switching accompanied by a color-space fluctuation of the first video data occurs in the video input device, for an output mute of the HDMI signal to the HDMI output device prior to an output of the first video data subjected to the input switching from the video input device;

outputting the first video data subjected to the switching from the video input device;

generating, through the color space converter, the second video data subjected to the switching which have the same color space as a color space of the second video data before the switching which are generated from the first video data before the switching, from the first video data subjected to the switching which are output from the video input device;

encrypting the second video data subjected to the switching through the encrypting device; and

cancelling the output mute of the HDMI output device and generating and outputting, through the HDMI converter, the HDMI signal subjected to the switching from the second video data subjected to the switching which are encrypted.

In this video/audio output apparatus controlling program, even if the input color space of the video data which are input to the video input device fluctuates, the output color space is not changed. Despite the HDMI signal transmission with the encryption, a reauthentication with the receiving apparatus is not carried out. Thus, it is possible to carry out control capable of exhibiting the function and effect obtained by the corresponding HDMI transmitting apparatus.

According to the present invention, in the input switch processing such as switching between a media drive and a tuner or an exchange of media of different types, the resolution of the first video data (the HDMI signal) does not fluctuate even if the resolution of the second video data is changed due to the input switch processing. Therefore, mismatching does not occur in a connecting relationship or an authenticating relationship between the HDMI transmitting apparatus and the receiving apparatus. Consequently, it is not necessary to stop the operation for outputting the HDMI signal from the HDMI transmitting apparatus to the receiving apparatus, and furthermore, to carry out the reauthentication in an output restart. As a result, it is possible to rapidly implement the input switch processing without causing a disturbance of an image. In particular, the reauthentication can be omitted when the encrypted video data are treated, which is very advantageous in respect of the rapid execution of the input switch processing.

The video/audio output apparatus according to the present invention can instantaneously output an image and a voice even if the input switching occurs, has an advantage on a quality basis, that is, a user can reduce a waiting time for input switching, and is useful for an AV apparatus having an HDMI connecting structure.

### BRIEF DESCRIPTION OF THE DRAWINGS

Other objects of the present invention will be apparent from understanding of an embodiment which will be described below and will be clarified in the appended claims. By executing the invention, numerous advantages which have not been described in the specification will be apparent to the skilled in the art.

FIG. 1 is a diagram showing a schematic structure of a system constituted by a video/audio output apparatus including an HDMI transmitting apparatus according to a first embodiment of the present invention and a receiving apparatus which is HDMI connected thereto;

FIG. 2 is an operation sequence diagram showing a video/audio output apparatus according to a second embodiment of the present invention;

FIG. 3 is a diagram showing a schematic structure of a system constituted by a video/audio output apparatus including an HDMI transmitting apparatus according to second and third embodiments of the present invention and a receiving apparatus which is HDMI connected thereto;

FIG. 4 is a diagram illustrating a resolution menu selection according to the second embodiment of the present invention;

FIG. 5 is a flowchart showing an operation of the video/audio output apparatus according to the second embodiment of the present invention;

FIG. 6 is a diagram showing a system structure of a video/audio output apparatus and a receiving apparatus in the prior art;

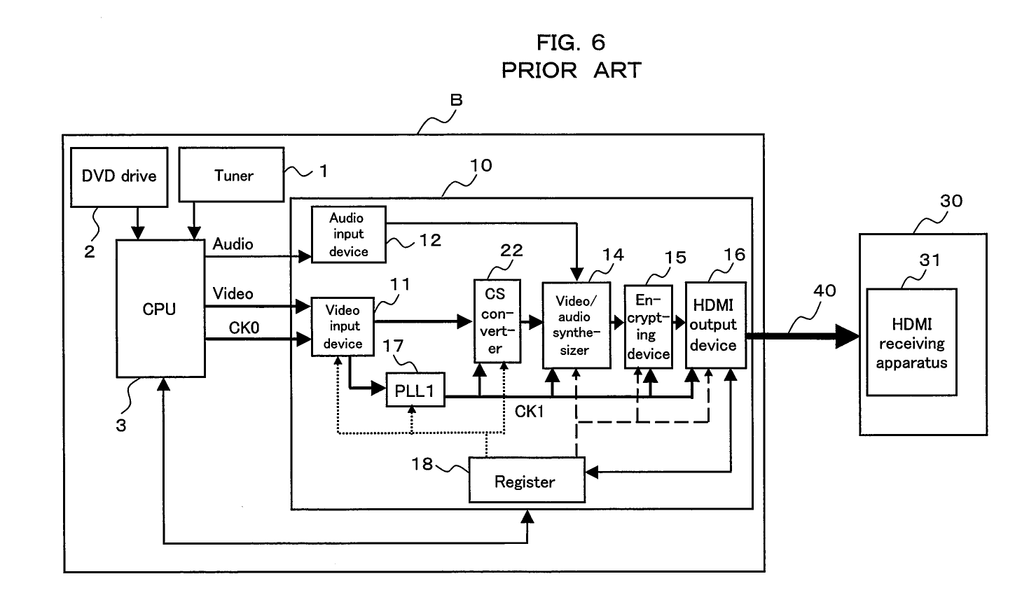

FIG. 7 is a sequence diagram showing an operation in input switch processing of the video/audio output apparatus according to the prior art;

FIG. 8 is an operation sequence diagram in input color space switching of the video/audio output apparatus according to the technique of the present invention; and

FIG. 9 is an operation sequence diagram in the input color space switching of the video/audio output apparatus according to the prior art.

### DETAILED DESCRIPTION OF THE INVENTION

Embodiments according to the present invention will be described below with reference to the drawings.

### First Embodiment

A first embodiment of a video/audio output apparatus according to the present invention will be described below in detail with reference to the drawings. The first embodiment relates to an HDMI transmitting apparatus having such a manner that a reauthentication with a receiving apparatus is not carried out even if a resolution of first video data to be input fluctuates. The video/audio output apparatus serves to carry out both a video transmission and an audio transmission.

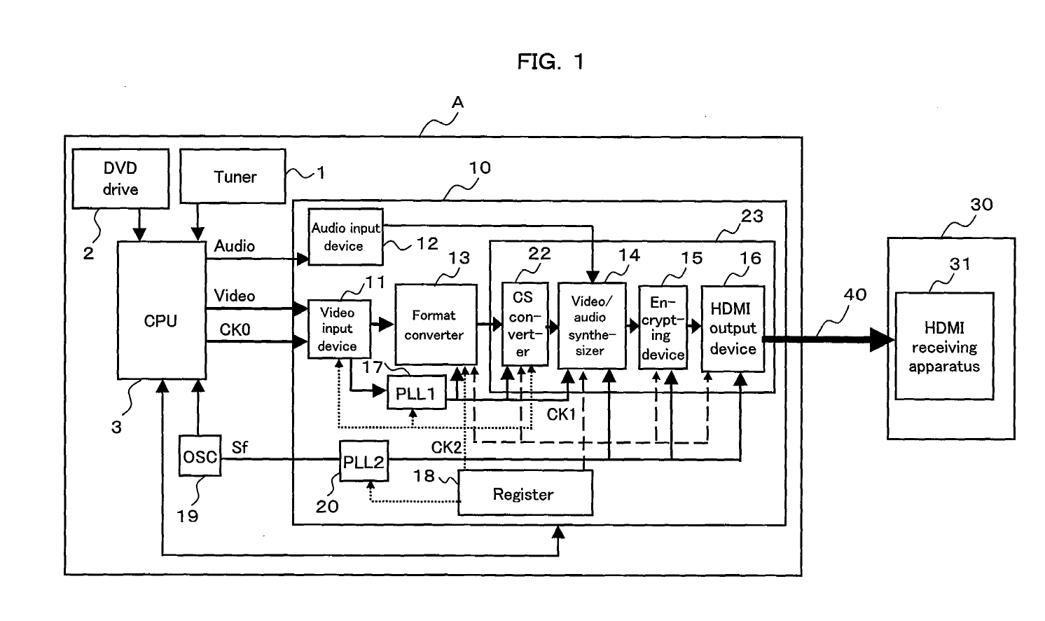

FIG. 1 is a diagram showing a schematic structure of a system including a video/audio output apparatus A having the HDMI transmitting apparatus according to the first embodiment of the present invention and a receiving apparatus 30 which is HDMI connected thereto. The video/audio output apparatus A and the receiving apparatus 30 are connected to each other through an HDMI cable 40. The HDMI transmitting apparatus 10 in the video/audio output apparatus A transmits the input video data and audio data to the receiving apparatus 30 via the HDMI cable 40.

The video/audio output apparatus A according to the present embodiment includes a tuner 1, a DVD drive 2, a CPU 3 having a built-in B/E LSI, and the HDMI transmitting apparatus 10. The HDMI transmitting apparatus 10 includes a video input device 11, an audio input device 12, a format converter 13, an HDMI converter 23, a first clock generator 17, a register 18, an internal oscillator (OSC) 19, and a second clock generator 20. The HDMI converter 23 includes a CS converter 22, a video/audio synthesizer 14, an encrypting device 15 and an HDMI output device 16.

First video data transmitted from the tuner 1 or the DVD drive 2 through the CPU 3 are input to the video input device 11. Audio data transmitted from the tuner 1 or the DVD drive 2 through the CPU 3 are input to the audio input device 12. The format converter 13 converts the resolution of the first video data output from the video input device 11 to a desired output resolution, thereby generating second video data. The CS converter 22 converts the color space of the second video data supplied from the format converter 13 into a desired output color space and outputs the second video data. The video/audio synthesizer 14 synchronizes the second video data obtained after the color space conversion which are supplied from the CS converter 22 with the audio data supplied from the audio input device 12 synchronously. The encrypting device 15 encrypts the video/audio synthesized data obtained by a synthesis through the video/audio synthesizer 14. The HDMI output device 16 converts the encrypted video/audio synthesized data output by the encrypting device 15 into the HDMI signal and outputs the HDMI signal to the outside. The first clock generator 17 generates a second clock signal CK1 having a frequency corresponding to a resolution obtained after the conversion of the format converter 13 based on a first clock signal CK0 input synchronously with the first video data in the video input device 11, and supplies the second clock signal CK1 thus generated to the format converter 13, the CS converter 22 and the video/audio synthesizer 14. The register 18 switches an operation mode of each portion upon receipt of a setting request given from the CPU 3. The second clock generator 20 generates a third clock signal CK2 having a frequency corresponding to an output resolution in the HDMI output device 16 based on an oscillating signal Sf output from an oscillator 19, and supplies the third clock signal CK2 thus generated to the CS converter 22, the video/audio synthesizer 14, the encrypting device 15 and the HDMI output device 16. 31 denotes an HDMI receiver provided in the receiving apparatus 30.

Referring to the first video data input to the video input device 11, in some cases, an input resolution fluctuates in input switch processing such as switching between the DVD drive 2 and the tuner 1 or an exchange of DVDs of different types. However, the format converter 13 has a structure in which the first video data are always converted so that they have a certain output resolution, and thereby the second video data are generated irrespective of a fluctuation in the input resolution. For example, when an output resolution of the second video data is preset to 1080P, an output resolution of the second video data is always 1080P irrespective of the input switch processing. When an input resolution of the first video data is changed from 1080P to 1080i with the input switch processing, a resolution conversion from 1080P to 1080P is changed to a resolution conversion of 1080i to 1080P in the processing of the format converter 13. Consequently, the output resolution of the second video data is maintained so that it remains constant and unchanged. Note that P in 1080P represents a progressive method and i in 1080i represents an interlacing method.

The second clock generator 20 generates the third clock signal independently of the first clock generator 17. More specifically, the second clock generator 20 generates the third clock signal CK2 based on the oscillating signal Sf of the oscillator 19. A frequency of the third clock signal CK2 corresponds to an output resolution (fixed) of the HDMI output device 16 and is always constant irrespective of the input switch processing. The third clock signal CK2 having a certain frequency is supplied to the video/audio synthesizer 14, the encrypting device 15 and the HDMI output device 16. As a result, unlike the prior art, the HDMI output device 16 is separated from the second clock signal CK1 having a changing frequency. The HDMI output device 16 carries out an operation for outputting the HDMI signal in accordance with the third clock signal CK2 supplied from the second clock generator 20 (generated independently of the second clock signal CK1).

While the input resolution of the first video data fluctuates, the output resolutions of the second video data and the HDMI signal are fixed. Therefore, the input resolution of the first video data which fluctuates is to be converted into the output resolution of the second video data or the HDMI signal which is fixed. For the conversion, the format converter 13 is provided. The format converter 13 converts the input resolution of the first video data which fluctuates so that it is coincident with the output resolution (the resolution of the second video data or the HDMI signal) in the HDMI output device 16 which is fixed.

The above structure being provided, in the input switch processing such as the switching between the DVD drive 2 and the tuner 1 or the exchange of the DVDs of different types, the output resolution (the resolution of the HDMI signal) does not fluctuate even if the input resolution (the resolution of the first video data) fluctuates due to the input switch processing. Accordingly, mismatching does not occur in a connecting relationship or an authenticating relationship between the HDMI transmitting apparatus 10 and the receiving apparatus 30. For this reason, it is not necessary to temporarily stop the HDMI signal output from the HDMI transmitting apparatus 10 to the receiving apparatus 30, thereby eliminating the necessity of both an output restart and a reauthentication. Accordingly, it is possible to rapidly implement the input switch processing without causing a disturbance of an image. More specifically, there is no waiting time of several seconds in the related art required for a switched image to be output again. Consequently, it is possible to output a switched image instantaneously.

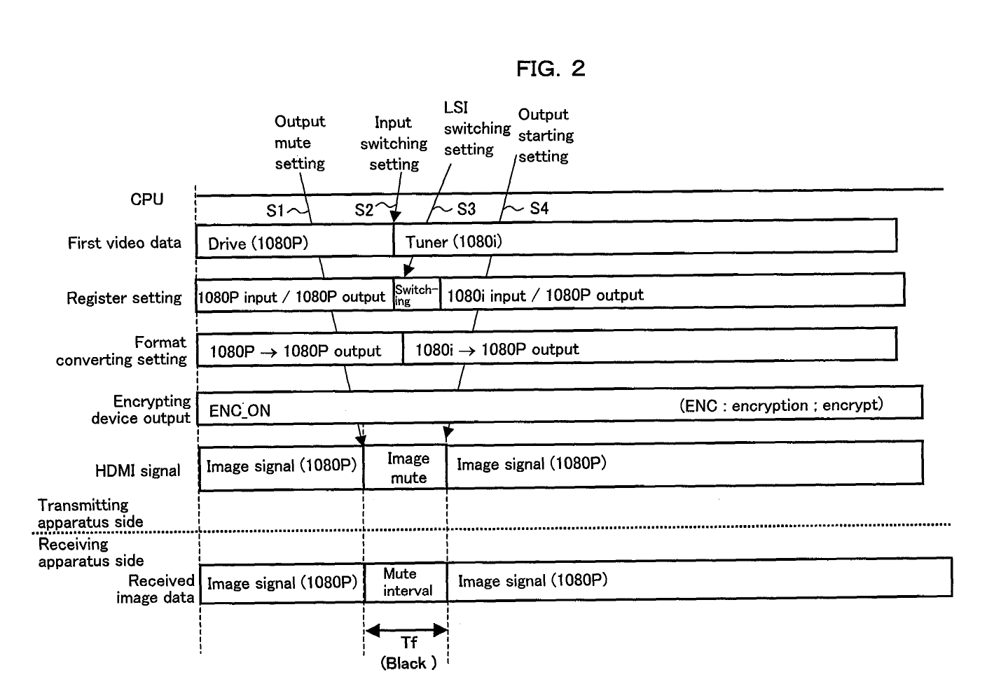

With reference to FIG. 2, next, description will be given to an operation sequence in the input switch processing of the video/audio output apparatus A according to the embodiment which has the above described structure (from the DVD drive 2 to the tuner 1). In the following description, it is assumed that before the input switch processing, the first video data supplied from the DVD drive 2 are input to the video input device 11 in such a state as to have a characteristic of the resolution of 1080P and are output from the HDMI output device 16 after the execution of predetermined processing.

When the input switching processing from the DVD drive 2 to the tuner 1 starts, the CPU 3 gives an instruction for the input switch processing to the register 18 and gives a notice of an output mute to the HDMI output device 16 (S1). Subsequently, the CPU 3 executes the input switch processing (from the DVD drive 2 to the tuner 1) (S2). Then, the CPU 3 gives the register 18 a notice that the input/output resolution is changed from 1080P→1080P to 1080i→1080P. The format converter 13 reads the input/output resolution given to the format converter 13 from the register 18 and carries out a format conversion (in this case, 1080i→1080P) appropriate for the input/output resolution thus read (S3). Although the resolution of the output (the resolution of the HDMI signal) is fixed, the input resolution (the resolution of the first video data) fluctuates. Therefore, the format converter 13 carries out the processing of converting the fluctuating input resolution into the fixed output resolution. Subsequently, the CPU 3 gives a notice of the output mute cancellation of the HDMI signal to the HDMI output device 16 via the register 18 (S4).

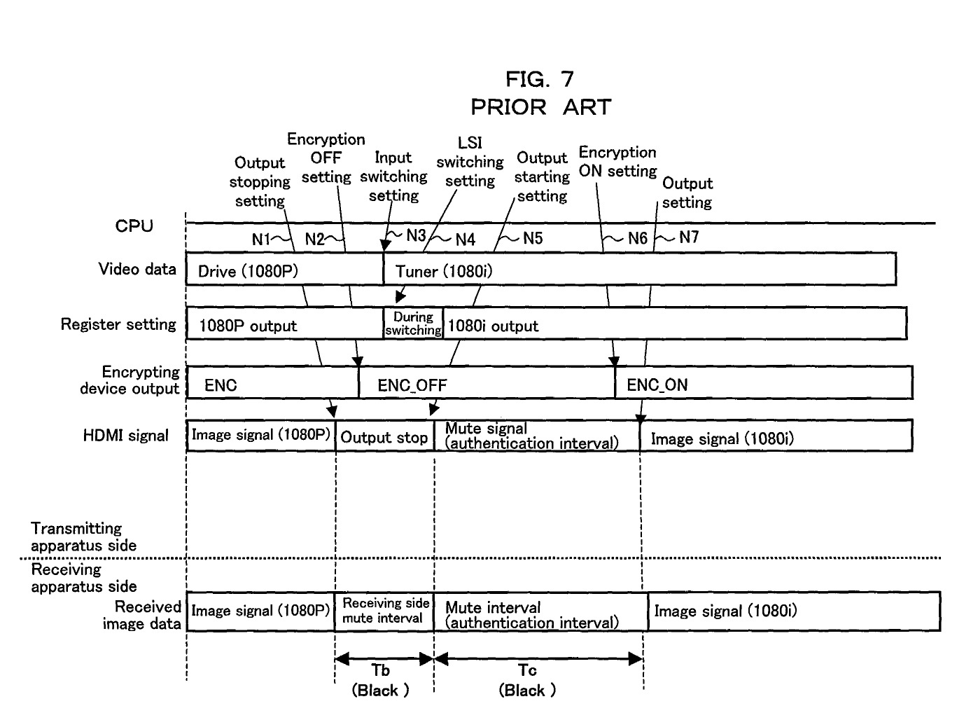

In the present embodiment, an interval Tf till the completion of image switch processing is varied depending on the system and can be shortened to several hundreds of ms (in contrast to several seconds in the prior art of FIG. 7). The switching from the tuner 1 to the DVD drive 2 can be dealt with in the same manner as described above. Moreover, the resolution (1080P) of the second video data given from the CPU 3 to the format converter 13 is fixed. Therefore, the case where the first video data having a resolution other than 1080P are input from the DVD drive 2 to the HDMI transmitting apparatus 10 can also be dealt with in the same manner as described above. Moreover, even the case in which the setting of the resolution of the first video data to be input to the HDMI transmitting apparatus 10 is changed as a result of the replacement of the media of the DVD drive 2 can be dealt with in the same manner as described above because the setting of the output resolution of the second video data in the format converter 13 is fixed. Furthermore, the case in which the encrypting device 15 is always set in an OFF state can also be dealt with in the same manner as described above.

Although FIG. 1 shows the structure in which the DVD drive 2 and the tuner 1 are provided, a structure in which only the DVD drive 2 or the tuner 1 can also be dealt with in the same manner as described above. The output resolution of the second video data is fixed in the format converter 13. In a structure in which a plurality of LSIs capable of carrying out a video output such as B/E LSIs, therefore, a configuration in which the first video data are switched into the video input device 11 and are thus input can also be dealt with in the same manner as described above. Moreover, the oscillator 19 may be provided in the HDMI transmitting apparatus 10. In addition, it is desirable that the oscillator 19 should have the same clock as that input to the CPU 3. Furthermore, it is also possible to employ a structure in which the audio input device 12 is not provided in the HDMI transmitting apparatus 10 and only the video output is carried out. Moreover, it is also possible to employ a structure in which the encrypting device 15 is not provided in the HDMI transmitting apparatus 10. In addition, the CPU 3 may be provided in the HDMI transmitting apparatus 10 and the HDMI transmitting apparatus 10 may be implemented in hardware such as an LSI. Accordingly, the CPU 3 and the HDMI transmitting apparatus 10 may be implemented in one chip.

### Second Embodiment

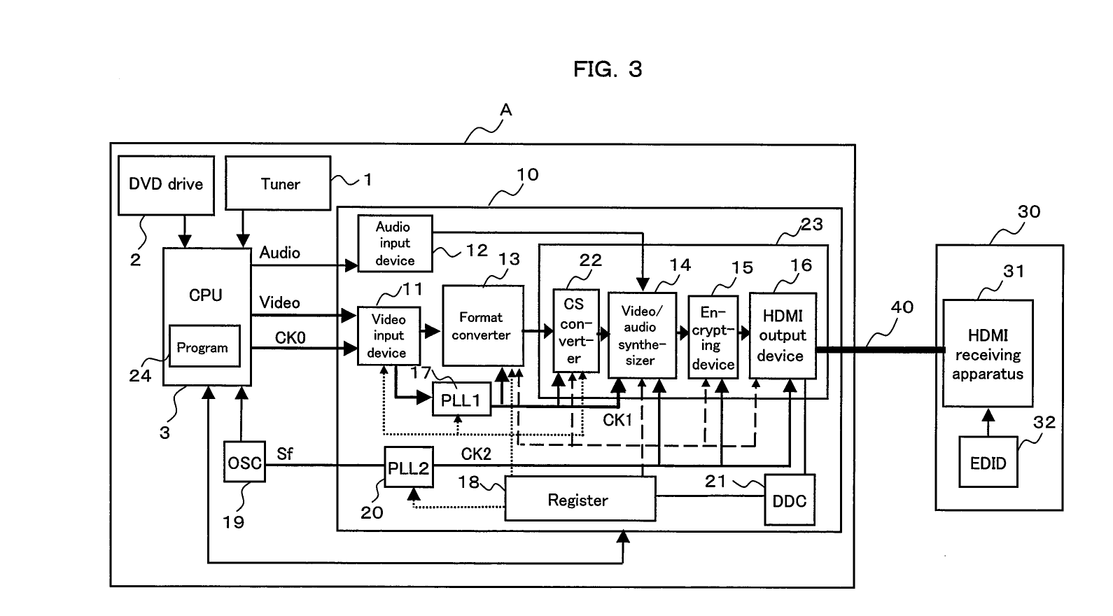

A second embodiment according to the present invention relates to an HDMI transmitting apparatus in the case in which the highest possible resolution the receiving side can receive is output. FIG. 3 is a diagram showing a schematic structure of a system constituted by a video/audio output apparatus A including the HDMI transmitting apparatus according to the second embodiment of the invention and a receiving apparatus 30 which is HDMI connected thereto. In FIG. 3, the same reference numerals as those in the first embodiment (FIG. 1) denote the same components. A peculiar structure to the present embodiment is as follows.

32 denotes EDID (Extended Display Identification Data) provided in the receiving apparatus 30 and describing a receiving capability, such as a resolution, of the receiving apparatus 30. In detail, the EDID 32 includes an image format, a resolution, an aspect ratio, a frame frequency, a color space, a voice type, a voice sampling frequency, a voice quantization bit number and the like. 21 denotes a DDC (Display Data Channel) block which is a low-speed two-way bus for transmitting/receiving information to be used in a plug and play operation and an authenticating operation of HDCP for a copyright. The EDID 32 is transmitted from the HDMI receiving apparatus 31 to the DDC block 21 through an HDMI cable 40. Furthermore, the EDID 32 is transmitted from the DDC block 21 to a CPU 3 via a register 18. The CPU 3 analyzes the contents of the acquired EDID 32 by using a built-in program 24 and thus grasps a resolution which can be received by the receiving apparatus 30. As a result of the analysis of the EDID 32, if the resolution receivable by the receiving apparatus 30 is 480P, 720P, 1080i or 1080P, for example, it is assumed that the CPU 3 always selects 1080P as the highest resolution. In the present embodiment, the DDC block 21 corresponds to a receiving capability information acquiring device, the CPU 3 corresponds to a receiving capability analyzing device, and the register 18 corresponds to a resolution setting device. Since the other structures are the same as those in the first embodiment, description will be omitted.

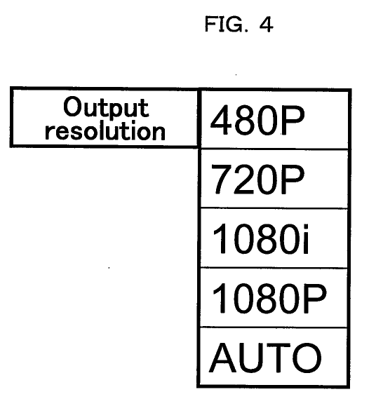

FIG. 4 shows an example of a resolution selecting menu output from the video/audio output apparatus A according to the present embodiment. The acquired EDID 32 is analyzed to display a receiving capability for a user as shown in FIG. 4. It is assumed that when AUTO is selected, the highest resolution is always selected. Moreover, a desired resolution may be fixed by the user. For example, when 1080i is selected, the resolution (output resolution) of the second video data or the HDMI signal always remains fixed to be the resolution of 1080i as set by the user at a last time even if the resolution of the first video data is changed by the input switch processing.

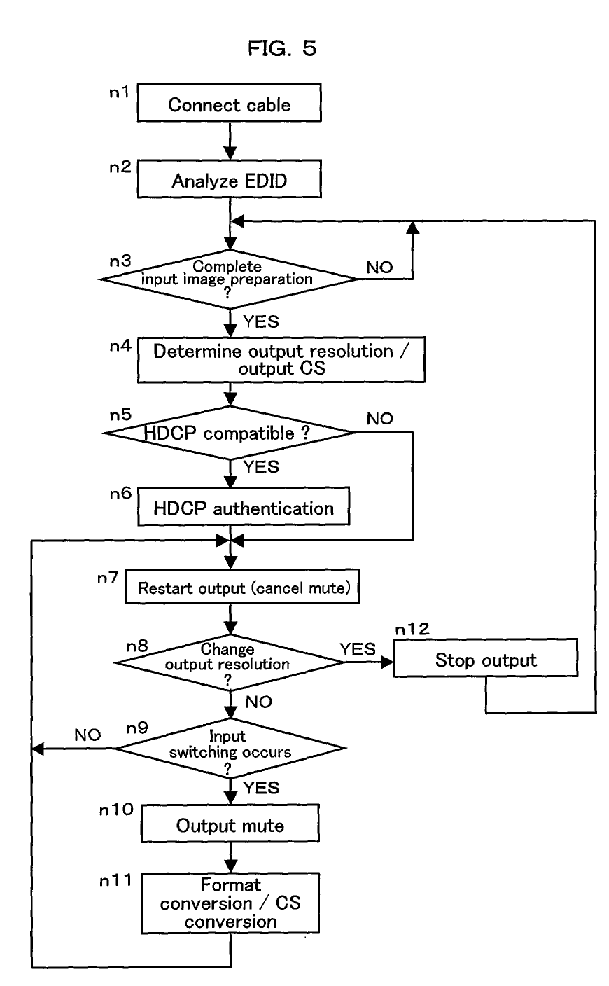

Next, an operation of the program 24 provided in the CPU 3 will be described with reference to a flowchart of FIG. 5. The program 24 is stored in a recording medium and is installed into the CPU 3. First of all, at Step n1, it is ascertained whether the HDMI transmitting apparatus 10 of the video/audio output apparatus A and the receiving apparatus 30 are connected to each other through the HDMI cable 40 or not. At Step n2, next, the EDID 32 in the receiving apparatus 30 is acquired and analyzed. At Step n3, then, it is ascertained whether an input image (first video data) is prepared and input to the HDMI transmitting apparatus 10 or not. At Step n4, thereafter, the highest resolution obtained as a result of the EDID analysis through the Step n2 is selected and a format conversion is carried out, and an HDMI signal set in a mute state starts to be output. In the processing, it is also possible to select a resolution selected and output by a user at the last time other than the highest resolution. At Step n5, subsequently, it is decided whether the receiving apparatus 30 is an HDCP compatible apparatus related to copyright protection or not. If the receiving apparatus 30 is an HDCP compatible apparatus, the processing proceeds to Step n6 in which HDCP authentication processing is executed. At Step n7, next, the output mute is cancelled and the HDMI signal is output at the output resolution determined at the Step n4. At Step n8, then, it is decided whether a request for changing the output resolution of the HDMI signal in the current output state of the HDMI signal in the menu selection through the user is given or not. If there is no change of the output resolution, the processing proceeds to Step n9. If there is a change, the processing proceeds to Step n12. When there is no change of the output resolution and the processing proceeds to the Step n9, it is decided whether the input switch processing occurs or not. If the input switch processing cannot be confirmed, the processing proceeds to the Step n7 in which the output of the HDMI signal is restarted (the mute cancellation). If the input switch processing can be confirmed, the processing proceeds to Step n10. At the Step n10 to which the processing proceeds when it is confirmed that the output resolution is not changed and the input switch processing occurs, the output mute of the HDMI signal is carried out. At Step nil, then, the format conversion of the first video data (the generation of the second video data and the HDMI signal) is executed and the processing proceeds to the Step n7 in which the output of the HDMI signal is restarted (the mute cancellation). A time interval in which the output mute of the HDMI signal is executed at the Step n10 corresponds to the Tf interval in FIG. 2. If it is decided that the output resolution (the resolution of the HDMI signal) is changed at the Step nB, the processing proceeds to the Step n12. At the Step n12, the output of the HDMI signal is stopped. After the output of the HDMI signal is stopped at the Step n12, the processing returns to judgment of the input preparation at the Step n3 and the output setting (Step n4) is carried out again. When the program 24 is executed as described above, an output image is output instantaneously in the input switch processing. After the output of the HDMI signal is stopped at the Step n12, a transition to the output set processing at the Step n4 may be carried out. A structure in which the encrypting device 15 is not provided can also be dealt with in the same manner as described above if the HDCP compatibility of the Step n5 and the HDCP authentication of the Step n6 are omitted from the flowchart of FIG. 5. Moreover, the CPU 3 may be provided in the HDMI transmitting apparatus 10, and the HDMI transmitting apparatus 10 may be implemented in hardware such as an LSI. Accordingly, the CPU 3 and the HDMI transmitting apparatus 10 may be implemented in one chip.

### Third Embodiment

A third embodiment according to the present invention relates to an HDMI transmitting apparatus having such a manner that a reauthentication with a receiving apparatus is not carried out even if a color space of first video data fluctuates. The HDMI transmitting apparatus carries out both video transmission and audio transmission. FIG. 3 is a diagram showing a schematic structure of a system including a video/audio output apparatus A having the HDMI transmitting apparatus according to the third embodiment of the present invention and a receiving apparatus 30 which is HDMI connected thereto. The video/audio output apparatus A and the receiving apparatus 30 are connected to each other through an HDMI cable 40. The HDMI transmitting apparatus 10 in the video/audio output apparatus A synthesizes the first video data and the audio data which are input, and generates an HDMI signal and transmits the HDMI signal to the receiving apparatus 30 via the HDMI cable 40.

The video/audio output apparatus A according to the present embodiment includes a tuner 1, a DVD drive 2, a CPU 3 having a built-in B/E LSI, and the HDMI transmitting apparatus 10. The HDMI transmitting apparatus 10 includes a video input device 11, an audio input device 12, a format converter 13, an HDMI converter 23, a first clock generator 17, a register 18, an internal oscillator (OSC) 19, and a second clock generator 20. The HDMI converter 23 includes a CS converter 22, a video/audio synthesizer 14, an encrypting device 15 and an HDMI output device 16.

First video data transmitted from the tuner 1 or the DVD drive 2 through the CPU 3 are input to the video input device 11. Audio data transmitted from the tuner 1 or the DVD drive 2 through the CPU 3 are input to the audio input device 12. The format converter 13 converts the resolution of the first video data output from the video input device 11 to a desired resolution, thereby generating second video data. The CS converter 22 converts a color space of the second video data supplied from the format converter 13 into a desired output color space and outputs the second video data. The video/audio synthesizer 14 synchronizes the second video data which are obtained after the color space conversion and are supplied from the CS converter 22 with the audio data supplied from the audio input device 12 synchronously. The encrypting device 15 encrypts the video/audio synthesized data obtained by a synthesis through the video/audio synthesizer 14. The HDMI output device 16 converts the encrypted video/audio synthesized data output by the encrypting device 15 into the HDMI signal and outputs the converted HDMI signal to the outside. The first clock generator 17 generates a second clock signal CK1 having a frequency corresponding to a resolution of the second video data subjected to a resolution conversion through the format converter 13 from the first clock signal CK0 input synchronously with the first video data to the video input device 11, and furthermore, supplies the second clock signal CK1 thus generated to the format converter 13, the CS converter 22 and the video/audio synthesizer 14. The register 18 switches an operation mode of each portion upon receipt of a setting request given from the CPU 3. The second clock generator 20 generates a third clock signal CK2 having a frequency corresponding to a resolution of the HDMI signal output from the HDMI output device 16 based on an oscillating signal Sf output from an oscillator 19, and supplies the third clock signal CK2 thus generated to the CS converter 22, the video/audio synthesizer 14, the encrypting device 15 and the HDMI output device 16. 31 denotes an HDMI receiver provided in the receiving apparatus 30.

In the input switch processing such as the switch between the DVD drive 2 and the tuner 1 or the exchange of DVDs of different types, the input resolution or color space of the first video data input to the video input device 11 fluctuates in some cases. The CS converter 22 converts the color space of the second video data which are input into a desired color space. Examples of the color space conversion include a conversion from an RGB signal (input) to a YCbCr signal (output) or a conversion from the YCbCr signal (input) to the RGB signal (output).

The second clock generator 20 generates the third clock signal CK2 based on the oscillating signal Sf sent from the oscillator 19 and generates the third clock signal independently of the first clock generator 17. The frequency of the third clock signal CK2 corresponds to the output resolution (fixed) of the HDMI signal output from the HDMI output device 16 and is always constant irrespective of the input switch processing. The third clock signal CK2 having a certain frequency is supplied to the video/audio synthesizer 14, the encrypting device 15 and the HDMI output device 16. As a result, unlike the prior art, the HDMI output device 16 is separated from the second clock signal CK1 having a changing frequency. The HDMI output device 16 carries out an operation for outputting the HDMI signal based on the third clock signal CK2 supplied from the second clock generator 20 (independently of the second clock signal CK1).

While the resolution/color space of the first video data fluctuates, the resolution of the HDMI signal (second video data) is fixed. For this reason, it is necessary to convert the fluctuating input resolution (the resolution of the first video data) into the fixed output resolution (the resolution of the HDMI signal (second video data)). For the conversion, the format converter 13 is provided. The format converter 13 converts the fluctuating input resolution in accordance with the fixed output resolution in the HDMI output device 16.

In the case in which the color space of the first video data is switched to generate the second video data (YCbCr←→RGB), a bus width of the second video data is usually changed from that of the first video data. For this reason, the first video signal is also interrupted instantaneously. With an output structure of the HDMI signal (second video data) based on the third clock signal which is fixed, as in the present embodiment, however, the second clock signal does not influence the third clock signal even if the bus width of the input fluctuates. Therefore, it is possible to output the HDMI signal (second video data) instantaneously.

As a result, in the input switch processing such as the switching between the DVD drive 2 and the tuner 1 or the exchange of DVDs of different types, the resolution of the second video data or the HDMI signal does not fluctuate even if the resolution/color space of the first video data is changed due to the input switch processing. Accordingly, mismatching does not occur in a connecting relationship or an authenticating relationship between the HDMI transmitting apparatus 10 and the receiving apparatus 30. For this reason, it is not necessary to stop the output of the HDMI signal from the HDMI transmitting apparatus 10 to the receiving apparatus 30, thereby eliminating the necessity of both an output restart and a reauthentication. In the input switch processing, accordingly, it is possible to rapidly implement the input switch processing without causing a disturbance of an image. More specifically, there is no waiting time of several seconds in the conventional art required for a switched image to be output again. Consequently, it is possible to output an image switched instantaneously.

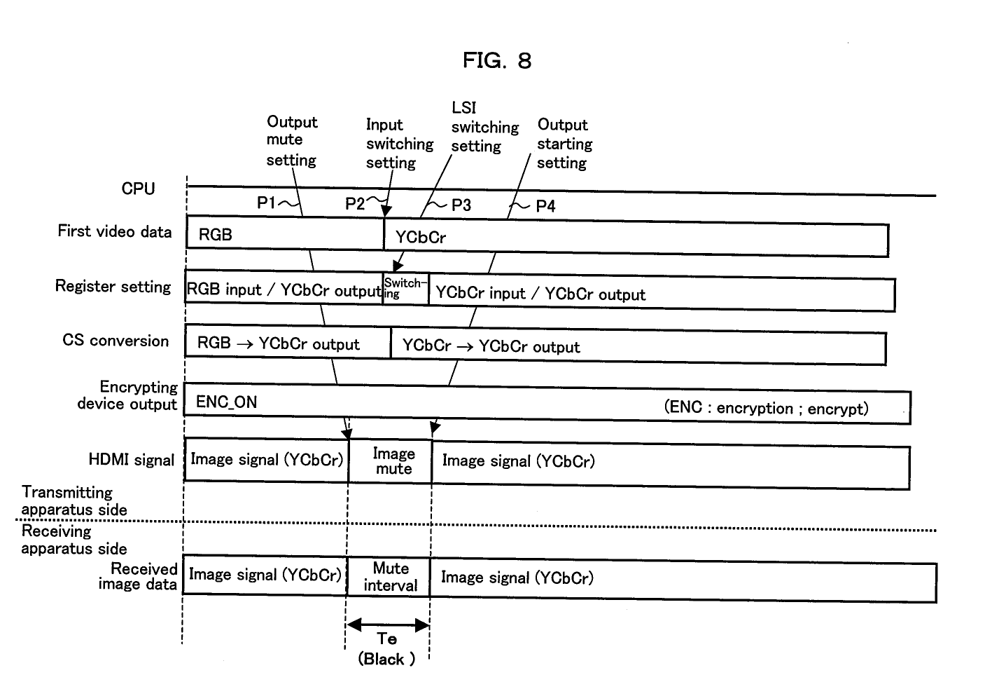

With reference to FIG. 8, next, description will be given to an operation sequence of the input color space switching (RGB→YCbCr) in the video/audio output apparatus A according to the present embodiment having the above described structure. In the following description, it is assumed that the first video data supplied from the DVD drive 2 are input in the color space (RGB signal) to the video input device 11 and are then output from the HDMI output device 16 through predetermined processing before the input switch processing.

When the color space of the first video data is switched through the exchange of the DVD in the DVD drive 2 or the like, the CPU 3 gives a request for the input switch processing to the register 18 and gives a notice of the output mute of the HDMI signal to the HDMI output device 16 (P1). Subsequently, the CPU 3 carries out the input switch processing (RGB→YCbCr) (P2). Then, the CPU 3 gives the register 18 a notice that the color space of the second video data input to the CS converter 22 is changed into RGB→YCbCr. Consequently, the CS converter 22 changes the conversion setting from the RGB→YCbCr to YCbCr→YCbCr (P3). Thereafter, a notice of the cancellation of the output mute of the HDMI signal is given to the HDMI output device 16 via the register 18 (P4).

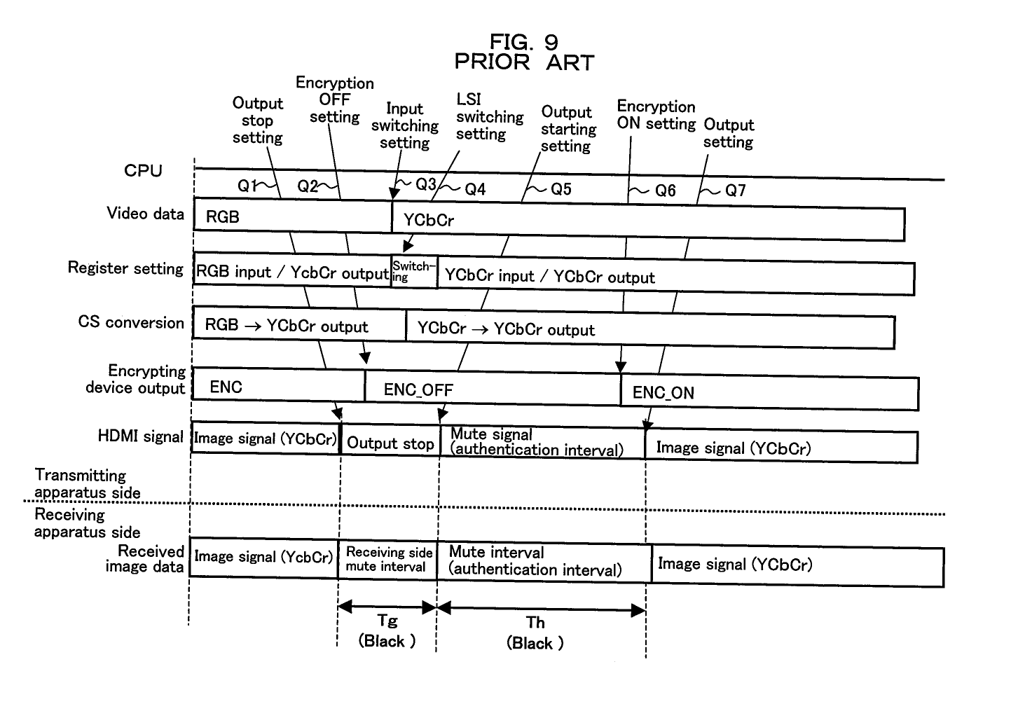

In the present embodiment, a time interval Te till the completion of image switch processing is varied depending on the system and can be shortened to several hundreds of ms (in contrast to several seconds in the prior art of FIG. 9). The switching from the tuner 1 to the DVD drive 2 can also be dealt with in the same manner as described above. In the CS converter 22, moreover, the color space (YCbCr) of the second video data given from the CPU 3 is fixed. Therefore, the case in which the first video data having the color space other than RGB are input from the tuner 1 to the HDMI transmitting apparatus 10 can also be dealt with in the same manner as described above. The case in which the encrypting device 15 is always set in the OFF state can also be dealt with in the same manner as described above.

FIG. 1 shows the structure in which the DVD drive 2 and the tuner 1 are provided. Note, however, that a structure in which only the DVD drive 2 or the tuner 1 is provided can also be dealt with in the same manner as described above. In the present example, there has been described the switching for changing the color space of the second video data from RGB to YCbCr and then preventing the color space from fluctuating in the HDMI signal (always YCbCr). Also in switching for changing the color space of the second video data from YCbCr to RGB and then preventing the color space from fluctuating in the HDMI signal (always RGB), the same effect can be obtained. Also in the case in which the input color space and the output color space are coincident with each other as exemplified by the input color space (RGB→YCbCr) and the output color space (RGB→YCbCr), the output clock is not influenced even if the bus width of the input is varied, according to the outputting method using a fixed clock in accordance with the present invention. Therefore, it is possible to instantaneously carry out the output.

Next, an operation of the program 24 provided in the CPU 3 will be described with reference to a flowchart of FIG. 5. The program 24 is stored in a recording medium and is installed into the CPU 3. First of all, at Step n1, it is ascertained whether the HDMI transmitting apparatus 10 of the video/audio output apparatus A and the receiving apparatus 30 are connected to each other through the HDMI cable 40 or not. At Step n2, next, the EDID 32 in the receiving apparatus 30 is acquired and analyzed. At Step n3, then, it is ascertained whether the input of the first video data is prepared and the first video data are input to the HDMI transmitting apparatus 10 or not. At Step n4, thereafter, the highest resolution obtained in the EDID analysis through the Step n2 is selected and the format conversion and the CS conversion for the first video data are carried out in the resolution to generate the second video data, and furthermore, the output of the HDMI signal which was in the mute state starts to be output. In the processing, it is also possible to select a resolution selected and output by a user at the last time other than the highest resolution. At Step n5, subsequently, it is decided whether the receiving apparatus 30 is an HDCP compatible apparatus related to copyright protection or not. If the receiving apparatus 30 is the HDCP compatible apparatus, the processing proceeds to Step n6 in which HDCP authentication processing is executed. At Step n7, next, the output mute of the HDMI signal is cancelled and the HDMI signal (video/audio synthesized data) is output in the resolution determined at the Step n4. At Step n8, then, it is decided whether or not a user gives a request for changing the output resolution (more specifically, the resolution of the second video data or the HDMI signal) in the video output state in the menu selection to be executed by the user. If there is no change of the output resolution, the processing proceeds to Step n9. If there is a change, the processing proceeds to Step n12. When there is no change of the output resolution and the processing proceeds to the Step n9, it is decided whether the input switch processing occurs or not. If the input switch processing cannot be confirmed, the processing proceeds to the Step n7 for restarting an image output (the mute cancellation). If the input switch processing can be confirmed, the processing proceeds to Step n10. At the Step n10 to which the processing proceeds when it is confirmed that the output resolution is not changed and the input switch processing occurs, the output mute of the HDMI signal is carried out. At Step n11, then, the format conversion and the output CS conversion are carried out to generate the second video data, and furthermore, the processing proceeds to the Step n7 in which the HDMI signal is output again (the mute cancellation). A time interval in which the output mute is executed at the Step n10 corresponds to the Te interval in FIG. 8. If it is decided that the output resolution is changed at the Step n8, the processing proceeds to the Step n12. At the Step n12, the output of the HDMI signal is stopped. After the output of the HDMI signal is stopped at the Step n12, the processing returns to judgment of the input preparation at the Step n3 and the output setting (Step n4) is carried out again.

In the input switch processing through the program, it is possible to instantaneously output an image. After the output of the HDMI signal is stopped at the Step n12, a transition to the determination of the output resolution at the Step n4 may be carried out. Also in a structure in which the encrypting device 15 is not provided, it is possible to obtain the same effect as described above by omitting the HDCP compatibility at the Step n5 and the HDCP authentication at the Step n6 from the flowchart of FIG. 5. Moreover, the CPU 3 may be provided in the HDMI transmitting apparatus 10 or the HDMI transmitting apparatus 10 may be implemented in hardware such as an LSI. Accordingly, the CPU 3 and the HDMI transmitting apparatus 10 may be implemented in one chip.

While the most preferred specific examples of the invention have been described in detail, the combinations and arrangements of components according to the preferred embodiments can be variously changed without departing from the sprit and scope of the invention described in the appended claims.

What is claimed is:

1. A video/audio output apparatus comprising:
a video input device for inputting first video data and a first clock signal which is synchronous with the first video data;
a format converter for resolution converting the first video data input to the video input device, thereby generating second video data;
an HDMI converter for converting the second video data into an HDMI signal;
a first clock generator for generating a second clock signal having a frequency corresponding to a resolution of the second video data based on the first clock signal input to the video input device and supplying the second clock signal to the format converter and the HDMI converter; and
a second clock generator for generating a third clock signal having a frequency corresponding to a resolution of the HDMI signal and supplying the third clock signal to the HDMI converter,
wherein the format converter converts the first video data into the second video data based on the first clock signal and the second clock signal, and
the HDMI converter converts the second video data into the HDMI signal based on the second clock signal and the third clock signal.

2. The video/audio output apparatus according to claim 1, wherein the HDMI converter includes
a color space converter for converting a color space of the second video data into a desired color space; and
an HDMI output device for converting, into the HDMI signal, the second video data subjected to the color space conversion,
the second clock signal is supplied to the format converter and the color space converter, and
the third clock signal is supplied to the HDMI output device.

3. The video/audio output apparatus according to claim 2, further comprising:
a receiving capability information acquiring device for acquiring receiving capability information from a receiving apparatus which is a transmitting destination of the HDMI signal;
a receiving capability analyzer for analyzing the receiving capability information acquired by the receiving capability information acquiring device, thereby calculating a maximum resolution which can be received by the receiving apparatus; and
a resolution setting device for setting the maximum resolution calculated by the receiving capability analyzer to the format converter and the HDMI output device.

4. The video/audio output apparatus according to claim 2, further comprising:
an audio input device for inputting audio data,
the HDMI converter further including a video/audio synthesizer for synthesizing the second video data and the audio data synchronously with the third clock signal, thereby generating video/audio synthesized data, and
the HDMI output device converting the video/audio synthesized data into the HDMI signal.

5. The video/audio output apparatus according to claim 2, wherein the HDMI converter further includes an encrypting device for encrypting the second video data synchronously with the second clock signal, and
the HDMI output device converts the second video data thus encrypted into the HDMI signal.

6. The video/audio output apparatus according to claim 4, wherein the HDMI converter further includes an encrypting device for encrypting the video/audio synthesized data synchronously with the third clock signal, and
the HDMI output device converts the video/audio synthesized data thus encrypted into the HDMI signal.

7. A recording medium for storing a program for executing a method of controlling the video/audio output apparatus according to claim 2, comprising the steps of:
giving an instruction, when input switching accompanied by a resolution fluctuation of the first video data occurs in the video input device, for an output mute of the HDMI signal to the HDMI output device prior to an output of the first video data subjected to the input switching from the video input device;
outputting the first video data subjected to the switching from the video input device;
generating, through the format converter, the second video data subjected to the switching which have a resolution equal to a resolution of the second video data before the switching which are generated from the first video data before the switching from the first video data subjected to the switching which are output from the video input device; and
cancelling the output mute of the HDMI output device and generating and outputting, through the HDMI output device, the HDMI signal subjected to the switching from the second video data subjected to the switching.

8. A recording medium for storing a program for executing a method of controlling the video/audio output apparatus according to claim 5, comprising the steps of:
giving an instruction, when input switching accompanied by a resolution fluctuation of the first video data occurs in the video input device, for an output mute of the HDMI signal to the HDMI output device prior to an output of the first video data subjected to the input switching from the video input device;
outputting the first video data subjected to the switching from the video input device;
generating, through the format converter, the second video data subjected to the switching which have a resolution equal to a resolution of the second video data before the switching which are generated from the first video data before the switching from the first video data subjected to the switching which are output, from the video input device;
encrypting the second video data subjected to the switching through the encrypting device; and
cancelling the output mute of the HDMI output device and generating and outputting, through the HDMI output device, the HDMI signal subjected to the switching from the second video data subjected to the switching which are encrypted.

9. A recording medium for storing a program for executing a method of controlling the video/audio output apparatus according to claim 6, comprising the steps of:
giving an instruction, when input switching accompanied by a resolution fluctuation in the first video data occurs in the video input device, for an output mute of the HDMI signal to the HDMI output device prior to an output of the first video data subjected to the input switching from the video input device;
outputting the first video data subjected to the switching from the video input device;
generating, through the format converter, the second video data subjected to the switching which have a resolution equal to a resolution of the second video data before the switching which are generated from the first video data before the switching, from the first video data subjected to the switching which are output from the video input device;
synthesizing the second video data subjected to the switching and the audio data synchronously with the third clock signal, thereby generating the video/audio synthesized data subjected to the switching through the video/audio synthesizer;
encrypting the video/audio synthesized data subjected to the switching through the encrypting device; and
cancelling the output mute of the HDMI output device and generating and outputting, through the HDMI output device, the HDMI signal subjected to the switching from the video/audio synthesized data subjected to the switching which are encrypted.

10. A recording medium for storing a program for executing a method of controlling the video/audio output apparatus according to claim 2, comprising the steps of:
giving an instruction, when input switching accompanied by a color-space fluctuation of the first video data occurs in the video input device, for an output mute of the HDMI signal to the HDMI output device prior to an output of the first video data subjected to the input switching from the video input device;
outputting the first video data subjected to the switching from the video input device;
generating, through the color space converter, the second video data subjected to the switching which have the same color space as a color space of the second video data before the switching which are generated from the first video data before the switching, from the first video data subjected to the switching which are output from the video input device; and
cancelling the output mute of the HDMI output device and generating and outputting, through the HDMI output device, the HDMI signal subjected to the switching from the second video data subjected to the switching.

11. A recording medium for storing a program for executing a method of controlling the video/audio output apparatus according to claim 5, comprising the steps of:
giving an instruction, when input switching accompanied by a color-space fluctuation of the first video data occurs in the video input device, for an output mute of the HDMI signal to the HDMI output device prior to an output of the first video data subjected to the input switching from the video input device;
outputting the first video data subjected to the switching from the video input device;
generating, through the color space converter, the second video data subjected to the switching which have the same color space as a color space of the second video data before the switching which are generated from the first video data before the switching, from the first video data subjected to the switching which are output from the video input device;
encrypting the second video data subjected to the switching through the encrypting device; and
cancelling the output mute of the HDMI output device and generating and outputting, through the HDMI output device, the HDMI signal subjected to the switching from the second video data subjected to the switching which are encrypted.

12. A recording medium for storing a program for executing a method of controlling the video/audio output apparatus according to claim 6, comprising the steps of:
giving an instruction, when input switching accompanied by a color-space fluctuation of the first video data occurs in the video input device, for an output mute of the HDMI signal to the HDMI output device prior to an output of the first video data subjected to the input switching from the video input device;
outputting the first video data subjected to the switching from the video input device;
generating, through the color space converter, the second video data subjected to the switching which have the same color space as a color space of the second video data before the switching which are generated from the first video data before the switching, from the first video data subjected to the switching which are output from the video input device;
synthesizing the second video data subjected to the switching and the audio data synchronously with the third clock signal, thereby generating the video/audio synthesized data subjected to the switching through the video/audio synthesizer;
encrypting the video/audio synthesized data subjected to the switching through the encrypting device; and
cancelling the output mute of the HDMI output device and generating and outputting, through the HDMI output device, the HDMI signal subjected to the switching from the video/audio synthesized data subjected to the switching which are encrypted.

13. A recording medium for storing a program for executing a resolution converting method comprising the steps of:
inputting first video data and a first clock signal which is synchronous with the first video data;
resolution converting the first video data to generate second video data;
converting the second video data into an HDMI signal;
generating a second clock signal having a frequency corresponding to a resolution of the second video data based on the first clock signal; and
generating a third clock signal having a frequency corresponding to a resolution of the HDMI signal,
wherein the HDMI signal is converted in accordance with the third clock signal at the step of converting the second video data into the HDMI signal.
